(19) United States
(12) Patent Application Publication
(10) Pub. No.: US 2026/0126319 A1
(43) Pub. Date: May 7, 2026

(54) KITCHEN ELECTRONIC SCALE

(71) Applicant: Zhijian Li, Yangzhou (CN)

(72) Inventor: Zhijian Li, Yangzhou (CN)

(21) Appl. No.: 18/948,337

(22) Filed: Nov. 14, 2024

(30) Foreign Application Priority Data
Nov. 2, 2024 (CN) 2024226725548

(51) Int. Cl. G01G 21/28; G01B 3/04; G01G 17/00; G01G 23/32; G01K 1/02; G01K 13/00

(52) U.S. Cl. CPC G01G 21/28; G01B 3/04; G01G 17/00; G01G 23/32; G01K 1/028; G01K 13/00; G01K 2207/02

(57) ABSTRACT

A kitchen electronic scale, includes a scale body, a host, and a thermometer. The thermometer includes a detection end and a connection end. The host includes a display screen, a timer and a control chip. A connection port is arranged on the host, and the connection end of the thermometer is electrically connected with the control chip through the connection port. The control chip is electrically connected with the display screen and the timer. The display screen is used for displaying the working conditions of the scale body, the timer and the thermometer. The kitchen electronic scale integrates the functions of weighing, temperature measurement and timing, and is able to meet various requirements of a user.

### TECHNICAL FIELD

The present application belongs to a technical field of electronic scales, in particular to a kitchen electronic scale.

### BACKGROUND

A kitchen electronic scale is one kind of commonly used tools in kitchen, which is mainly used for accurately measuring weights of food materials. It is very important for baking, cooking and other activities that require strict control of the proportion of food materials. A kitchen electronic scale mainly comprises a scale body and a host. The scale body is used for carrying objects to be weighed, and the host is generally equipped with a display screen for displaying the weight reading of the objects.

For some dishes with higher cooking requirements, in addition to the requirements of weight proportion of food materials, it is also necessary to detect a current cooking temperature and set a cooking time in order to make a perfect dish. However, an existing kitchen electronic scale usually only has a weighing function and cannot satisfy various requirements of a user. A user needs to additionally purchase a thermometer and a timer, which incurs an additional cost.

Therefore, it is desired to provide a kitchen electronic scale capable of meeting various requirements of a user.

### SUMMARY

In order to overcome the shortcomings in prior art, the present application provides a kitchen electronic scale. The kitchen electronic scale integrates the functions of weighing, temperature measurement and timing, and is able to meet various requirements of a user.

The technical solution adopted by the present application for solving the technical problems is:

A kitchen electronic scale, comprises a scale body and a host, as well as a thermometer. The thermometer includes a detection end and a connection end. The host includes a display screen, a timer and a control chip. A connection port is arranged on the host, and the connection end of the thermometer is electrically connected with the control chip through the connection port. The control chip is electrically connected with the display screen and the timer. The display screen is used for displaying the working conditions of the scale body, the timer and the thermometer.

As a further improvement of the solution, the scale body and the host are designed in a split manner. The scale body is internally provided with a wireless transmitting module and weight detection modules. The host is internally provided with a wireless receiving module. The control chip is electrically connected with the wireless receiving module. The wireless transmitting module is connected with the wireless receiving module, and the weight detection modules are connected with the wireless transmitting module.

As a further improvement of the solution, one end of the host is provided with slots, and each slot is provided with a first magnet. One end of the scale body is provided with protruding blocks, and each protruding block is internally provided with a second magnet. The protruding block's contour is correspondingly adapted to the slot's contour.

As a further improvement of the solution, one end of the host is provided with protruding structures, and one end of the scale body is provided with fasteners. The fasteners are adapted to the protruding structures.

As a further improvement of the solution, a measuring plate is arranged on the scale body's surface, and two adjacent edges of the measuring plate are provided with scaling numbers.

As a further improvement of the solution, the scale body includes a scale upper shell and a scale lower shell. The scale upper shell is connected with the scale lower shell and forms a first cavity, and a first sealing member is arranged at the joint of the scale upper shell and the scale lower shell. The host includes a host upper shell and a host lower shell. The host upper shell is connected with the host lower shell and forms a second cavity, and a second sealing member is arranged at the joint of the host upper shell and the host lower shell.

As a further improvement of the solution, the scale lower shell is provided with four scale feet. Connecting lines among the four scale feet form a rectangle, and each scale foot is provided with the weight detection module.

As a further improvement of the solution, the scale foot includes a silicone case and a silicone ring. The silicone case is provided with an annular groove, and the silicone ring is embedded into the annular groove to form a nested structure with the silicone case. The scale lower shell is provided with scale foot mounting holes. Each scale foot mounting hole is adapted to the silicone case. The silicone case and the silicone ring seal the scale foot mounting hole. A fixed groove is arranged on one side of the silicone case facing towards the first cavity, and the weight detection module is arranged in the fixed groove.

As a further improvement of the solution, the scale lower shell and the host lower shell are both provided with a battery compartment and a battery cover plate. The battery compartment is provided with a battery, and the battery cover plate is able to cover or open the battery compartment. A third sealing member is arranged at the joint of the battery cover plate and the battery compartment, and the third sealing member is able to separate the battery compartment from an external environment.

As a further improvement of the solution, one side of the scale lower shell and one side of the host lower shell are both provided with a physical switch. The physical switch is electrically connected with the battery, and a waterproof rubber sleeve is arranged on the outer periphery of the physical switch.

The beneficial effect of the present application is:

The present application provides a kitchen electronic scale, comprising a scale body, a host and a thermometer. The host includes a display screen, a timer and a control chip, and the control chip is electrically connected with the display screen, the thermometer and the timer, which enables the kitchen electronic scale to integrate the functions of weighing, temperature measurement and timing so as to meet various requirements of a user.

### BRIEF DESCRIPTION OF DRAWINGS

FIG. 1 is a schematic diagram of the overall of the kitchen electronic scale with the thermometer unconnected in the Embodiment 1 of the present application;

FIG. 2 is a schematic diagram of the host in the Embodiment 1 of the present application;

FIG. 3 is a schematic diagram of the host connected with the thermometer in the Embodiment 1 of the present application;

FIG. 4 is an explosive diagram of the host in the Embodiment 1 of the present application;

FIG. 5 is a schematic diagram of the scale body in the Embodiment 1 of the present application;

FIG. 6 is a schematic diagram from another angle of the scale body in the Embodiment 1 of the present application;

FIG. 7 is an explosive diagram of the scale body in the Embodiment 1 of the present application;

FIG. 8 is an explosive diagram from another angle of the scale body in the Embodiment 1 of the present application;

FIG. 9 is a schematic diagram of the scale foot in the Embodiment 1 of the present application;

FIG. 10 is a schematic diagram of the host in the Embodiment 2 of the present application;

FIG. 11 is a schematic diagram of the scale body in the Embodiment 2 of the present application;

FIG. 12 is a schematic diagram of the protruding structure and the fastener in a connected state in the Embodiment 2 of the present application;

Note of the reference signs:
1—scale body; 10—connection groove; 101—protruding block; 102—second magnet; 11—measuring plate; 111—scaling numbers; 12—scale upper shell; 121—avoidance slot; 122—connection column; 13—scale lower shell; 131—first recess; 132—scale foot mounting hole; 133—connection hole; 14—first sealing member; 15—first PCB board; 16—scale foot; 161—silicone case; 162—silicone ring; 163—weighing sensor; 164—fixed groove; 17—fastener; 170—first mounting base; 171—first mounting hole;
2—host; 20—connection port; 201—chock plug; 21—slot; 211—first magnet; 212—protruding structure; 213—second mounting base; 2131—second mounting hole; 22—host upper shell; 221—key hole; 23—host lower shell; 231—second recess; 24—second sealing member; 25—second PCB board; 26—liquid crystal display screen; 261—backlight; 27—key; 271—third PCB board; 272—touch switch; 28—glass panel; 29—conductive adhesive strip;
3—thermometer; 30—detection end; 31—connection end;
4—battery compartment; 40—battery; 41—battery cover plate; 42—third sealing member; 43—physical switch; 44—waterproof rubber sleeve.

### DESCRIPTION OF EMBODIMENTS

In order to fully understand the purposes, features and effect of the present application, the following clearly and completely describes the ideas, specific structures and technical effects of the present application with reference to the embodiments and drawings of the present application. Apparently, the described embodiments are merely some but not all of the embodiments of the present application. Based on the embodiments of the present application, all the other embodiments obtained by those of ordinary skills in the art without creative work are all within the scope of protection of the present application. In addition, all the “linkage/connection” relationship in the present application does not simply mean a direct contact of components, but a better-preferred linkage/connection structure according to specific implementation situations by adding or reducing linkage/connection auxiliary components. The various technical features in the present application can be combined interchangeably without conflicting with each other.

### Embodiment 1

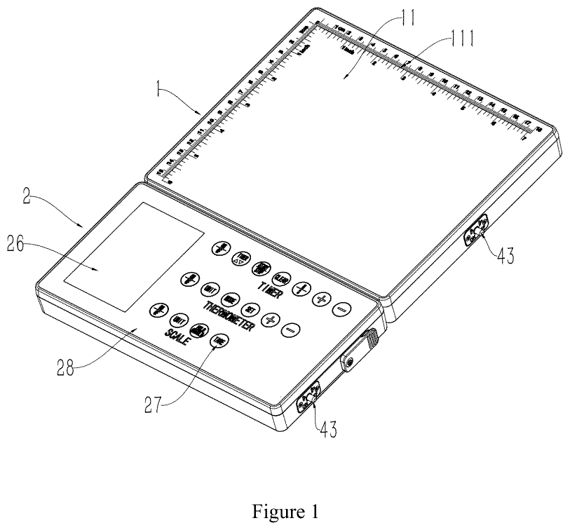

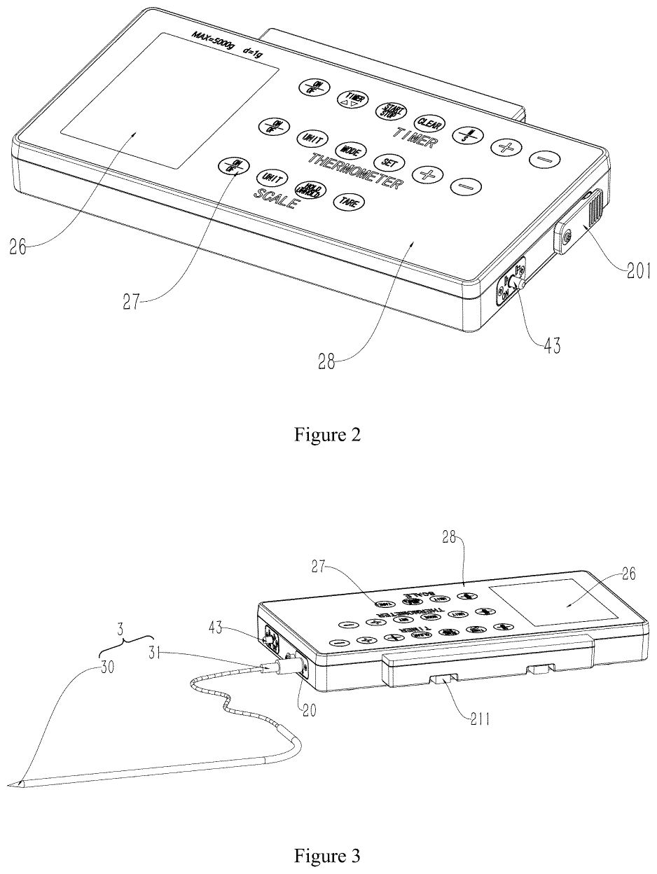

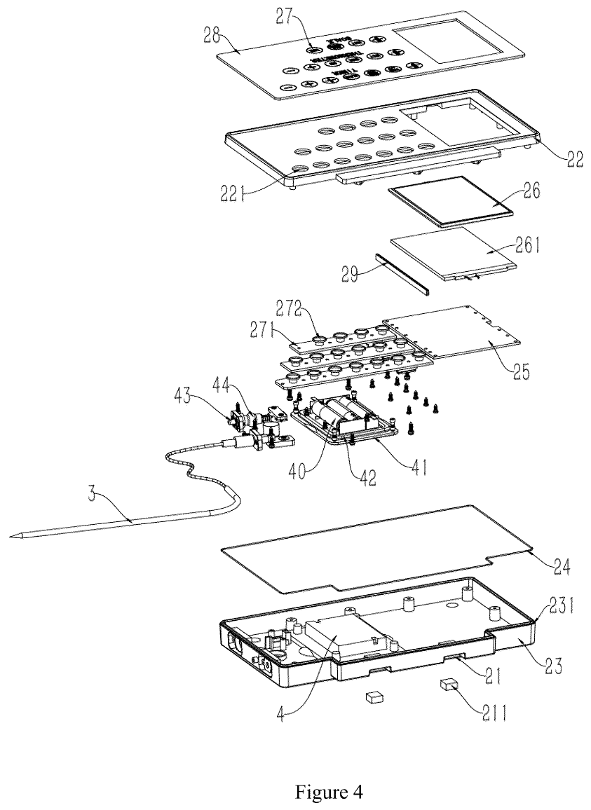

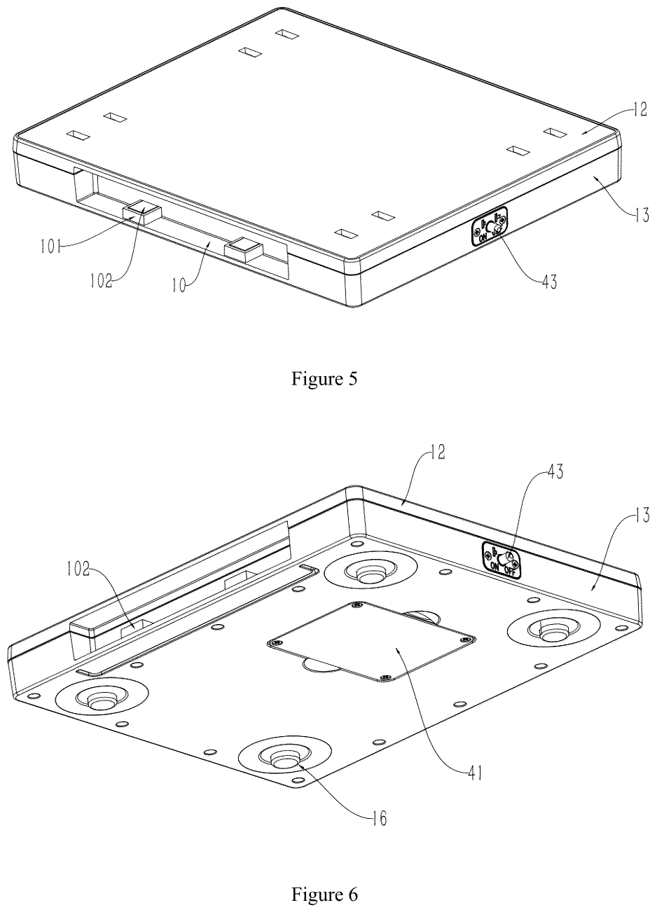

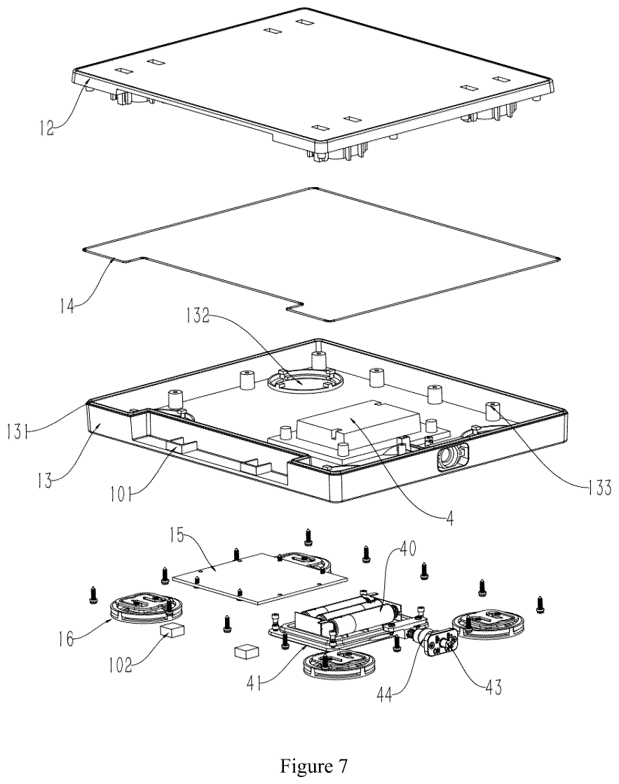

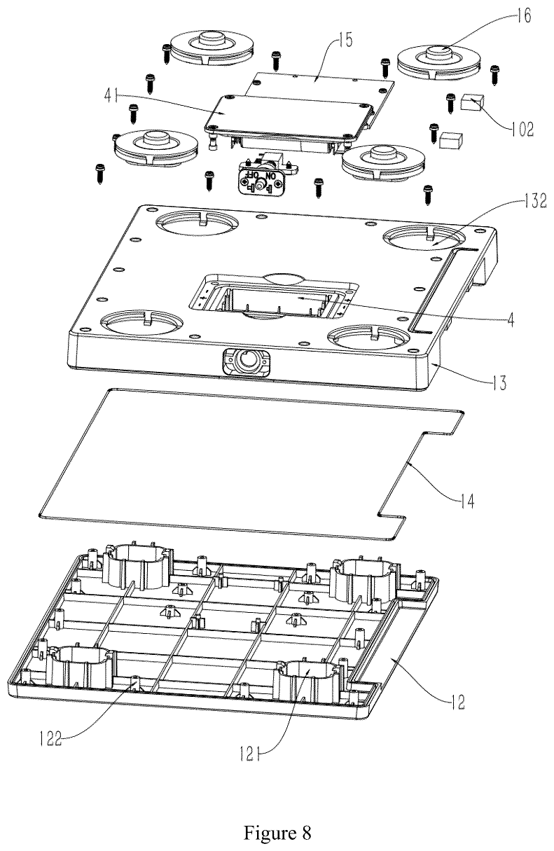

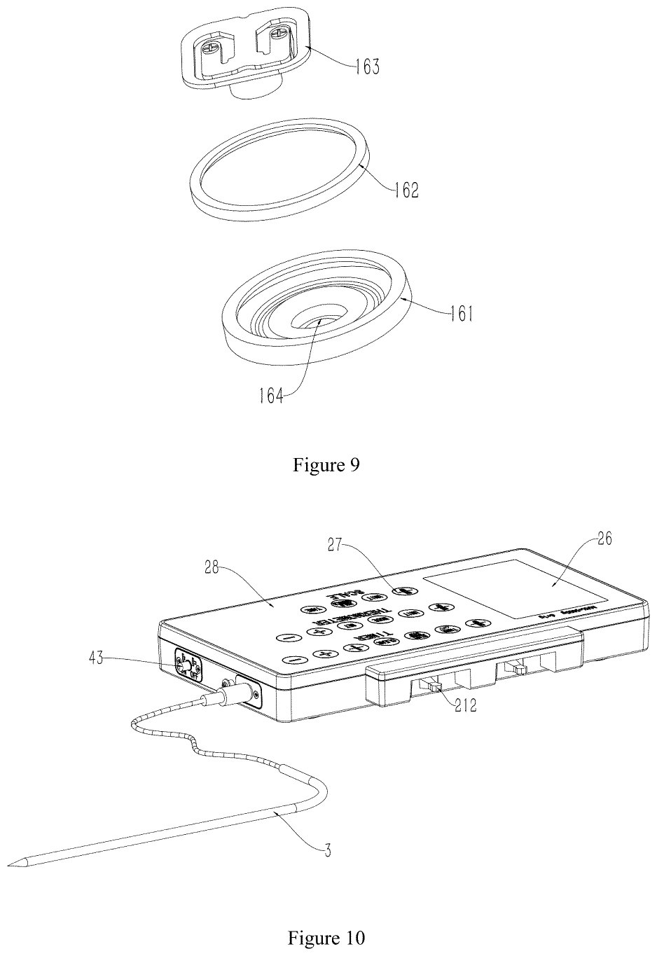

Referring to FIGS. 1 to 9, the present embodiment provides a kitchen electronic scale, comprising a scale body 1, a host 2, and a thermometer 3. The thermometer 3 includes a detection end 30 and a connection end 31. The host 2 includes a display screen, a timer and a control chip. A connection port 20 is arranged on the host 2, and the connection end 31 of the thermometer 3 is electrically connected with the control chip through the connection port 20. The control chip is electrically connected with the display screen and the timer.

The display screen is used for displaying the working conditions of the scale body 1, the timer and the thermometer 3. Particularly, the working condition of the scale body 1 refers to the detected weight data. The control chip receives the weight data and controls the weight data to be displayed on the display screen. The working condition of the timer refers to the prompt time data. The control chip receives the time data of the timer and controls the time data to be displayed on the display screen. The working condition of the thermometer 3 refers to the detected temperature data. The detection end 30 of the thermometer 3 is used for contacting with objects to be detected, obtaining the temperature data of the objects to be detected, and sending the temperature data to the control chip. The control chip receives the temperature data and controls the temperature data to be displayed on the display screen.

It should be noted that the timer has functions of timing and countdown. The display screen is provided with corresponding keys, and a user can choose the timing or countdown function according to the user's cooking requirements.

Preferably, when the thermometer 3 is not in use, there is a chock plug 201 arranged on the connection port 20 of the host 2 to prevent dust and water vapor from entering into the host 2 along the connection part. When the thermometer 3 is required to be connected with the connection port 20, the chock plug 201 is taken down from the connection port 20, and the connection end 31 of the thermometer 3 is inserted into the connection port 20.

Preferably, the scale body 1 and the host 2 are designed in a split manner. The scale body 1 is internally provided with a wireless transmitting module and weight detection modules. The host 2 is internally provided with a wireless receiving module. The wireless transmitting module is connected with the wireless receiving module, and the weight detection modules are connected with the wireless transmitting module. The weight detection modules send the detected weight information to the wireless transmitting module, and the wireless transmitting module sends the received weight information to the wireless receiving module.

When using a conventional electronic scale integrated with the scale body 1 and the host 2 to weigh a large-volume object, the display screen may be blocked by the object; if the object contains a liquid or a powder, it is possible to drop the stain onto the display screen, resulting in that the user can hardly observe the condition of the display screen. However, in the present embodiment, the scale body 1 and the host 2 are designed in a split manner, and the host 2 can be placed in a larger range. Even the kitchen electronic scale is weighing a large-volume object, the weighing result will not be invisible due to the shielding of the display screen.

Further, one end of the host 2 is provided with slots 21, and each slot 21 is provided with a first magnet 211. One end of the scale body 1 is provided with a connection groove 10, and protruding blocks 101 are arranged in the connection groove 10. Each protruding block 101 is internally provided with a second magnet 102. The protruding block's 101 contour is correspondingly adapted to the slot's 21 contour. When the kitchen electronic scale provided by the present embodiment is not used by the user, the protruding blocks 101 are inserted into the slots 21, and the first magnet 211 and the second magnet 102 are attracted under the action of magnetic force, so that the host 2 and the scale body 1 are connected due to the magnetic attraction, which makes the kitchen electronic scale convenient for storage.

In the present embodiment, the type of the control chip is VKV2. In an actual application, another chip may be selected as an alternative.

In the present embodiment, a measuring plate 11 is arranged on the scale body's 1 surface, and two adjacent edges of the measuring plate 11 are provided with scaling numbers 111. The scale body 1 is able to measure size at the same time of weighing. When the user applies the kitchen electronic scale in the present embodiment into a kitchen application scenario, the kitchen electronic scale is able to measure the size, i.e., length and width, of the food materials to determine whether the size of the food materials is acceptable in order to present the best taste of the food materials.

The scale body 1 includes a scale upper shell 12 and a scale lower shell 13. The scale upper shell 12 is connected with the scale lower shell 13 and forms a first cavity, and the wireless transmitting module and the weight detection modules are arranged in the first cavity. The scale upper shell 12 is provided with multiple connection columns 122, and the scale lower shell 13 is provided with multiple connection holes 133. The connection columns 122 are adapted to the connection holes 133. By inserting the connection columns 122 into the corresponding connection holes 133, a preliminary connection between the scale upper shell 12 and the scale lower shell 13 is realized. The scale upper shell 12 and the scale lower shell 13 are then tightly locked through multiple screws to form a stable connection relationship.

A first sealing member 14 is arranged at the joint of the scale lower shell 13 and the scale upper shell 12. The scale lower shell 13 is provided with a first recess 131, and the first sealing member 14 is arranged in the first recess 131. When the scale upper shell 12 is connected with the scale lower shell 13, the first sealing member 14 is able to realize the sealing effect to prevent water vapor and dust from entering into the scale body 1 along the connection part.

A first PCB board 15 is arranged in the first cavity, and the first PCB board 15 is fixedly connected to the inner side of the scale upper shell 12 through screws. The first PCB board 15 is electrically connected with the wireless transmitting module and the weight detection modules. The first PCB board 15 is used for receiving the weight data detected by the weight detection modules, transforming the weight data to data signals, and controlling the wireless transmitting module to send the data signals to the wireless receiving module to finally display on the display screen.

The scale lower shell 13 is provided with four scale feet 16. Connecting lines among the four scale feet 16 form a rectangle, and each scale foot 16 is provided with the weight detection module. The weight detection module selects a weighing sensor 163. Four weighing sensors 163 are able to measure the weight of the object simultaneously, and obtain a more comprehensive weight distribution information compared to a single sensor. By synthetically processing the data of the four weighing sensors 163, an actual weight of the object is determined more accurately and reducing the measurement errors caused by uneven object placement position or gravity center offset.

In addition, the data of the four weighing sensors 163 is verified interchangeably. If the data of a certain weighing sensor 163 appears a larger error than the data of other weighing sensors 163, it is determined that a fault may exist in the weighing sensor 163, and the fault information is fed back to the first PCB board. The first PCB board 15 controls an error code to be displayed on the display screen, which is helpful for the user to timely discover and repair the fault to ensure the accuracy and reliability of the kitchen electronic scale.

It can be understood that the weighing sensor 163 in this embodiment is a half-bridge sensor, and those skilled in the technical field of weighing are familiar with the operation principles of the half-bridge sensor. In another embodiment, the half-bridge sensor can be replaced with a parallel beam weighing sensor. The half-bridge sensor is a mature technical means in the industry, and it is not repeated herein.

Further, the scale foot 16 includes a silicone case 161 and a silicone ring 162. The silicone case 161 is provided with an annular groove, and the silicone ring 162 is embedded into the annular groove to form a nested structure with the silicone case 161. The scale lower shell 13 is provided with scale foot mounting holes 132. Each scale foot mounting hole 132 is adapted to the silicone case 161. The silicone case 161 and the silicone ring 162 seal the scale foot mounting hole 132. A fixed groove 164 is arranged on one side of the silicone case 161 facing towards the first cavity, and the weighing sensor 163 is arranged in the fixed groove 164. The scale upper shell 12 is provided with avoidance slots 121 for avoiding the weighing sensors 163 to make the interior structure of the scale body 1 more compact and save the space.

The host 2 includes a host upper shell 22 and a host lower shell 23. The host upper shell 22 is connected with the host lower shell 23 and forms a second cavity, and the wireless receiving module is arranged in the second cavity.

A second sealing member 24 is arranged at the joint of the host lower shell 23 and the host upper shell 22. The host lower shell 23 is provided with a second recess 231, and the second sealing member 24 is arranged in the second recess 231. When the host upper shell 22 is connected with the host lower shell 23, the second sealing member 24 is able to realize the sealing effect to prevent water vapor and dust from entering into the host 2 along the connection part.

Further, a second PCB board 25 is arranged in the second cavity, and both the control chip and the wireless receiving module are welded on the second PCB board 25.

Particularly, the display screen includes a liquid crystal display screen 26 and a backlight 261. The liquid crystal display screen 26 is electrically connected with the backlight 261, and the backlight 261 is electrically connected with the second PCB board 25 through a conductive adhesive strip 29.

The scale lower shell 13 and the host lower shell 23 are both provided with a battery compartment 4 and a battery cover plate 41. The battery compartment 4 is provided with a battery 40, and the battery cover plate 41 is able to cover or open the battery compartment 4. A third sealing member 42 is arranged at the joint of the battery cover plate 41 and the battery compartment 4, and the third sealing member 42 is able to separate the battery compartment 4 from an external environment to prevent water vapor and dust from entering into the battery compartment 4 to affect the normal operation of the battery 40. The battery 40 arranged in the scale lower shell 13 is electrically connected with the first PCB board 15 to supply power for the first PCB board 15. The battery 40 arranged in the host lower shell 23 is electrically connected with the second PCB board 25 to supply power for the second PCB board 25.

One side of the scale lower shell 13 and one side of the host lower shell 23 are both provided with a physical switch 43. The physical switch 43 is electrically connected with the battery 40. When the kitchen electronic scale provided by the present embodiment is not used by the user, the power supply is completely cut off through the physical switch 43 to prevent the battery 40 from remaining in a standby state for a long time, and prolong the endurance time of the battery 40. It should be noted that those skilled in the art should be clear about the principles for cutting off the power supply by the physical switch 43, which is not repeated herein.

Further, a waterproof rubber sleeve 44 is arranged on the outer periphery of the physical switch 43, which is waterproof and moisture-proof, and is able to protect the electronic elements in the scale body 1 from being damaged.

In the present embodiment, the host 2 further includes a functional module, and the functional module includes a plurality of keys 27 and third PCB boards 271. The third PCB boards 271 are provided with touch switches 272, and the amount of the touch switches 272 is adapted to the amount of keys 27. The keys 27 are configured on the touch switches 272, and the third PCB boards 271 are electrically connected with the second PCB board 25. Through the cooperation between the touch switches 272 and the control chip, different functions of the host 2 are started. The host upper shell 22 is provided with a plurality of key holes 221 corresponding to the touch switches 272, and the keys 27 extend out of the host upper shell 22 along the key holes 221. A glass panel 28 is arranged on a surface of the host upper shell 22 to protect the keys 27 from being affected by water vapor and dust and keep the keys 27 in a normal operation.

Common electronic scales on the market have fewer keys 27. A button is usually integrated with multiple functions, and corresponding functions are switched by long pressing or short pressing, which makes the operation complex and not visualized. The kitchen electronic scale provided by the present embodiment achieves that each key 27 corresponds to a function by arranging a plurality of keys 27 and touch switches 272. The keys 27 are provided with corresponding function names so that the operation is more simple and clear.

Preferably, the display screen in the present embodiment is provided with three display zones, and the three display zones are respectively used for displaying the time data, temperature data and weight data. Keys 27 for controlling the display zone are arranged beside each display zone. In other words, the keys 27 in the three display zone are able to control and operate independently, and the display and turn-off of each display zone are controlled by the keys 27 in the display zone.

### Embodiment 2

The present embodiment differs from the Embodiment 1 in the connection structure between the host 2 and the scale body 1, in particular, replacing the magnetic attraction structure in the Embodiment 1 with a fastener structure.

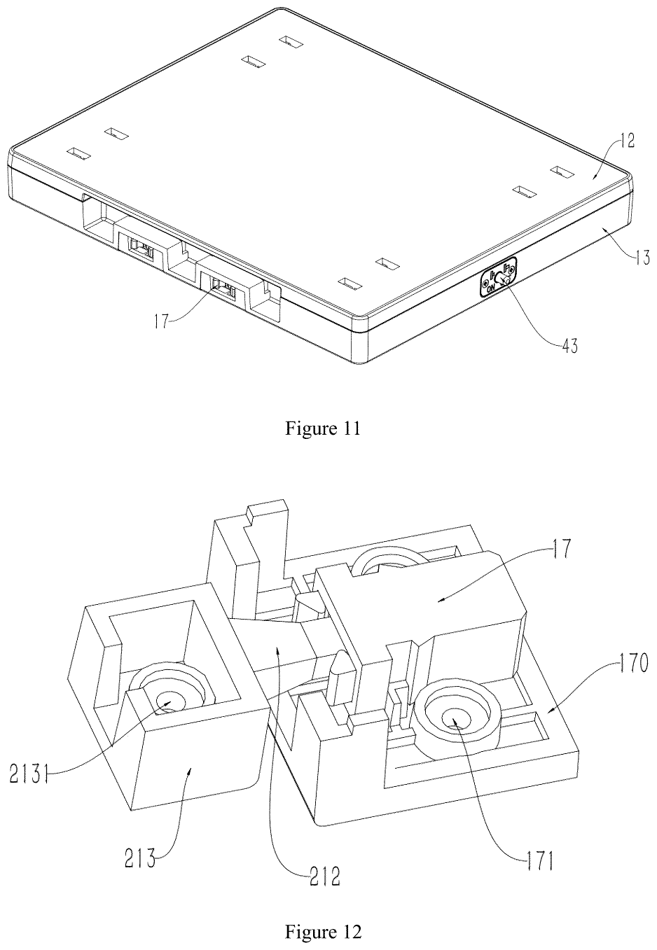

Referring to FIGS. 10 to 12, in the present embodiment, protruding structures 212 are arranged on one end of the host 2, and fasteners 17 are arranged on one end of the scale body 1. The fasteners 17 are adapted to the protruding structures 212. Only the protruding structures 212 are needed to be aligned with the fasteners 17, and the protruding structures 212 are embedded into the fasteners 17 under the pushing of manpower, so that the connection between the host 2 and the scale body 1 is realized. If the connection relationship needs to be released, only the protruding structures 212 are needed to be pushed again along the direction of the fasteners 17, the protruding structures 212 are separated from the fasteners.

Preferably, each fastener 17 is connected with a first mounting base 170, and each protruding structure 212 is connected with a second mounting base 213.

Further, the first mounting base 170 is provided with a first mounting hole 171, and the first mounting base 170 is fixed and connected to the scale body 1 through the cooperation of a screw and the first mounting hole 171. The second mounting base 213 is provided with a second mounting hole 2131, and the second mounting base 213 is fixed and connected to the host 2 through the cooperation of a screw and the second mounting hole 2131.

It should be noted that the fastener 17 and the protruding structure 212 belong to the standard components in the industry. Those skilled in the art should be clear about the cooperation principles of the fastener 17 and the protruding structure 212, and they can directly apply the components.

It can be understood that, under the guidance of the above embodiments, those skilled in the art can combine various implementation methods in the above embodiments to obtain a technical solution of multiple implementation methods.

The above descriptions are only preferred embodiments of the present application and are not intended to limit the present application. Any modifications, equivalent substitutions and improvements made within the spirit and principles of the present application are all within the protection scope of the present application.

1. A kitchen electronic scale, comprises a scale body and a host, and a thermometer, wherein the thermometer includes a detection end and a connection end; the host includes a display screen, a timer and a control chip; a connection port is arranged on the host, and the connection end of the thermometer is electrically connected with the control chip through the connection port; the control chip is electrically connected with the display screen and the timer; the display screen is used for displaying the working conditions of the scale body, the timer and the thermometer.

2. The kitchen electronic scale according to claim 1, wherein the scale body and the host are designed in a split manner; the scale body is internally provided with a wireless transmitting module and weight detection modules, and the host is internally provided with a wireless receiving module; the control chip is electrically connected with the wireless receiving module, the wireless transmitting module is connected with the wireless receiving module, and the weight detection modules are connected with the wireless transmitting module.

3. The kitchen electronic scale according to claim 1, wherein one end of the host is provided with slots, and each slot is provided with a first magnet; one end of the scale body is provided with protruding blocks, and each protruding block is internally provided with a second magnet;
the protruding block's contour is correspondingly adapted to the slot's contour.

4. The kitchen electronic scale according to claim 1, wherein one end of the host is provided with protruding structures, and one end of the scale body is provided with fasteners; the fasteners are adapted to the protruding structures.

5. The kitchen electronic scale according to claim 1, wherein a measuring plate is arranged on the scale body's surface, and two adjacent edges of the measuring plate are provided with scaling numbers.

6. The kitchen electronic scale according to claim 1, wherein the scale body includes a scale upper shell and a scale lower shell; the scale upper shell is connected with the scale lower shell and forms a first cavity, and a first sealing member is arranged at the joint of the scale upper shell and the scale lower shell; the host includes a host upper shell and a host lower shell; the host upper shell is connected with the host lower shell and forms a second cavity, and a second sealing member is arranged at the joint of the host upper shell and the host lower shell.

7. The kitchen electronic scale according to claim 6, wherein the scale lower shell is provided with four scale feet; connecting lines among the four scale feet form a rectangle, and each scale foot is provided with the weight detection module.

8. The kitchen electronic scale according to claim 7, wherein the scale foot includes a silicone case and a silicone ring; the silicone case is provided with an annular groove, and the silicone ring is embedded into the annular groove to form a nested structure with the silicone case; the scale lower shell is provided with scale foot mounting holes, and each scale foot mounting hole is adapted to the silicone case; the silicone case and the silicone ring seal the scale foot mounting hole; a fixed groove is arranged on one side of the silicone case facing towards the first cavity, and the weight detection module is arranged in the fixed groove.

9. The kitchen electronic scale according to claim 6, wherein the scale lower shell and the host lower shell are both provided with a battery compartment and a battery cover plate; the battery compartment is provided with a battery, and the battery cover plate is able to cover or open the battery compartment; a third sealing member is arranged at the joint of the battery cover plate and the battery compartment, and the third sealing member is able to separate the battery compartment from an external environment.

10. The kitchen electronic scale according to claim 9, wherein one side of the scale lower shell and one side of the host lower shell are respectively provided with a physical switch; the physical switch is electrically connected with the battery, and a waterproof rubber sleeve is arranged on the outer periphery of the physical switch.
